(19) United States
(12) Patent Application Publication
(10) Pub. No.: US 2017/0214207 A1
(43) Pub. Date: Jul. 27, 2017

(54) EXTRACTING TOOL FOR MODULE COMPONENT

(71) Applicant: FUJITSU LIMITED, Kawasaki-shi (JP)

(72) Inventor: Tsuyoshi Yamamoto, Kawasaki (JP)

(73) Assignee: FUJITSU LIMITED, Kawasaki-shi (JP)

(21) Appl. No.: 15/406,961

(22) Filed: Jan. 16, 2017

(30) Foreign Application Priority Data
Jan. 22, 2016 (JP) 2016-010703

(51) Int. Cl. H01R 43/26; H01R 13/633; B25B 27/02

(52) U.S. Cl. CPC H01R 43/26; B25B 27/02; H01R 13/6335

(57) ABSTRACT

An extracting tool for a module component, the extracting tool includes: a first member including, at a front end portion thereof, a hook that is engaged with a stepped portion formed a module component that is fitted to a cage and locked by a lock plate, the stepped portion being formed at a portion on the module component which is exposed from the cage; and a second member coupled with the first member at a rear end portion thereof, and including, at a front end portion thereof, a blade that, when the hook is engaged with the stepped portion, is inserted into a gap between the module component and the cage and pushes the locking plate upward to release a locked state.

### CROSS-REFERENCE TO RELATED APPLICATION

This application is based upon and claims the benefit of priority of the prior Japanese Patent Application No. 2016-010703, filed on Jan. 22, 2016, the entire contents of which are incorporated herein by reference.

### FIELD

The embodiments discussed herein are related to an extracting tool for a module component.

### BACKGROUND

In the related art, an electronic device such as a computer or a storage device may be connected, through an optical cable, with a transceiver, a calculating device or the like positioned away from the electronic device. In this case, a module component is mounted on a printed circuit board of the electronic device to perform conversion between an optical signal and an electric signal. The module component converts the optical signal into the electric signal and vice versa. Further, an optical signal converted from an electric signal by the module component is transmitted to the transceiver, the calculating device, or the like positioned away from the electronic device through the optical cable connected to the module component. On the contrary, an optical signal transmitted to the electronic device from the transceiver, the calculating device, or the like positioned away from the electronic device is converted into an electric signal by the module component, and then transmitted to the printed circuit board.

Further, as one of structures for mounting such a module component, there is an optical interface in which a module component is detachably equipped in a frame-shaped cage attachment connector mounted on a printed circuit board. In the case of the optical interface, one end of the cage of the frame-shaped cage attachment connector mounted on the printed circuit board is opened at a lateral side of the electronic device. When the module component is equipped in the electronic device, the module component is slid and inserted into and fitted to the opening of the cage. Because the cage includes a lock mechanism to lock the module component in a state where the module is fitted to the cage, the module component inserted into the cage is not easily pulled out. Meanwhile, because the module component includes a release mechanism to unlock the cage and the module component, an external force is applied to the release mechanism to unlock the cage and the module component when releasing the module component from the cage.

FIG. 1 is an explanatory view illustrating a structure of a communication device between a first electronic device 1 and a second electronic device 2 using module components 5 and optical cables 7. The first electronic device 1 and the second electronic device 2 may be, for example, a server or a storage device. Switch units 3, each of which is provided with a cage 4, the module component 5, and an optical connector 6, are embedded in the first electronic device 1 and the second electronic device 2, respectively, and the switch units 3 are connected to each other through the optical cables 7. The switch units 3 are configured to convert an optical signal transmitted/received through the optical cables into an electric signal. In addition, because the structures of the switch units 3 of the first electronic device 1 and the second electronic device 2 are identical to each other, the switch unit 3 of the first electronic device 1 will be representatively described in comparative technologies and exemplary embodiments of the present application which will be described below. Hereinafter, the first electronic device 1 will be simply referred to as an “electronic device 1”.

FIG. 2 is a perspective view illustrating a state in which the optical cable 7 is removed from the module component 5 mounted to the electronic device 1. The electronic device 1 is equipped with the cage 4 that is mounted on a circuit board (not illustrated) disposed in the electronic device 1, and the module component 5 is removably fitted to the cage 4. The optical cable 7 is configured to be removable from/insertable into an optical connector accommodating opening 56 provided at one end portion of the module component 5 via the optical connector 6. Because the structure of the optical connector 6 is known in the related art, the descriptions of the structure of the optical connector 6 will be omitted.

FIG. 3A is a perspective view illustrating a state in which the optical cable 7 is connected, via the optical connector 6, to the module component 5 extracted from the electronic device 1 illustrated in FIG. 2. In addition, FIG. 3B is a perspective view illustrating a state in which the optical cable 7 and the module component 5 are separated from each other by removing the optical connector 6 from the module component 5 illustrated in FIG. 3A. In addition, FIG. 4A is a side view of an example of the module component 5, and FIG. 4B is a top plan view of the module component 5 illustrated in FIG. 4A. The module component 5 is provided with a tapered portion 15 configured to be moved up and down by a lever device 10 to be described in detail below, and a locking protrusion 52 configured to lock the module component 5 to the cage 4. The lever device 10 includes an unlocking lever 13 configure to be rotatable about a rotating shaft 11.

FIG. 5 is a perspective view of an example of the cage 4 that equipped in the electronic device 1 to accommodate the module component 5. The cage 4 is a metallic component. A main body 40 of the cage 4 is provided with attachment legs 41 to mount the cage 4 on the circuit board, and an opening portion 44 configured to receive the module component 5 illustrated in FIGS. 4A and 4B to the inside of the cage 4. On a wall surface at the side where the attachment legs 41 of the opening portion 44 are disposed, a locking plate 43 is disposed to lock the module component 5 inserted into the cage 4. The locking plate 43 has a tongue shape such that the center side of the cage 4 is supported in a cantilevered manner and the opening portion 44 side is pivotable. A locking protrusion fitting hole 42 is provided at the central portion of the locking plate 43 to receive the locking protrusion 52 protruding from the module component 5.

FIG. 6A is a side view illustrating a state immediately before the module component 5 is inserted into the opening portion 44 of the cage 4 mounted on the circuit board 8 embedded in the electronic device 1. The module component 5 is slid and inserted into the cage 4 from the opening portion 44 in a state in which the unlocking lever 13 of the lever device 10 overlaps with a housing 50 and the locking protrusion 52 is positioned at the top side. FIG. 6B is a side view illustrating a state in which the module component 5 is fully inserted into and fitted to the cage 4 illustrated in FIG. 6A. In this state, a part of the housing 50 at the unlocking lever 13 side of the module component 5 protrudes to the outside of the electronic device 1, and a stepped portion 51 of the module component 5 is exposed to be spaced apart from the outer portion of the case of the electronic device 1 by a predetermined interval.

FIG. 6C is a side view illustrating a state in which the module component 5 is being removed from the state illustrated in FIG. 6B. When removing the module component 5 from the cage 4, first, the unlocking lever 13 is rotated and drawn up from the housing 50 to be positioned horizontally. When the unlocking lever 13 is rotated to the horizontal position, and then pulled, the locked state between the locking protrusion of the module component 5 and the locking plate 43 of the cage 4 is released by the release mechanism to be described below. Therefore, when the module component 5 is pulled in the horizontal direction to the state illustrated in FIG. 6C, the module component 5 may be pulled out from the cage 4 as illustrated in FIG. 6D.

FIG. 7A is a perspective view illustrating shapes of the unlocking lever 13 and slide rods 14 of the lever device 10 provided on the module component 5. The lever device 10 includes a main body 12, the unlocking lever 13 configured to be rotatable about the rotating shaft 11 provided on the main body 12, and two (2) slide rods 14 which protrude from the main body 12 toward the opposite side to the unlocking lever 13. The tapered portion 15 is formed at a free end of each slide rod 14. When the unlocking lever 13 is rotated about the rotating shaft 11 and pulled and the slide rods 14 are moved from a position indicated by a solid line to a position indicated by an alternate long and two short dashes line in FIG. 7B, the slide rods 14 are moved in a direction indicated by an arrow R, and the tapered portions 15 are moved to the position indicated by the alternate long and two short dashes line.

FIG. 7C is a partially enlarged cross-sectional view illustrating a relationship among the unlocking lever 13, the locking plate 43, and the locking protrusion 52 in a state in which the unlocking lever 13 is not drawn up. In the state in which the unlocking lever 13 is not drawn up, the tapered portions 15 formed at the free end of the slide rods 14 are accommodated in a tapered portion accommodating groove 55 formed in the housing 50 of the module component 5. An inclined surface 53 for receiving the tapered portions 15 is formed in the tapered portion accommodating groove 55, and as the tapered portions 15 are accommodated in the tapered portion accommodating groove 55, the slide rods 14 become parallel with the top surface 54 of the housing 50 of the module component 5. In addition, in a state where the tapered portions 15 are accommodated in the tapered portion accommodating groove 55, the locking plate 43 of the cage 4 is positioned in the vicinity of the tapered portions 15, and the front end portion of the locking protrusion 52 protruding from the top surface 54 of the housing 50 is inserted into the locking protrusion fitting hole 42 of the locking plate 43. As the front end portion of the locking protrusion 52 is inserted into the locking protrusion fitting hole 42 of the locking plate 43, the module component 5 is locked in the cage 4 such that the module component 5 may not be pulled out from the cage 4.

Further, when the unlocking lever 13 is drawn up to a position indicated by a broken line in FIG. 7B and then pulled, the slide rods 14 are moved in the direction indicated by the arrow R as illustrated in FIG. 7D, and the tapered portions 15 in the tapered portion accommodating groove 55 are moved upward along the inclined surface 53 and moved out of the tapered portion accommodating groove 55. When the tapered portions 15 are moved upward along the inclined surface 53, the portions of the tapered portions 15, which is positioned at the opposite side to the inclined surface 53, push the locking plate 43 upward. Then, the locking protrusion 52 locked by the locking plate 43 is unlocked, and as a result, the module component 5 is able to be pulled out from the cage 4 in this state.

FIGS. 8A to 8F illustrate operations of the locking plate 43 and the locking protrusion 52 in the states in which the module component 5 is inserted into and locked to the cage 4, and when the module component 5 is pulled out from the cage 4. When the module component 5 is inserted into the cage 4, the locking plate 43 is pushed upward on the inclined surface of the locking protrusion 52 as illustrated in FIGS. 8A and 8B. In the state in which the module component 5 is fully inserted into the cage 4, the locking protrusion 52 is inserted into the locking protrusion fitting hole 42 of the locking plate 43 as illustrated in FIGS. 8C and 8D, the locking plate 43 returns back to a position before the locking plate 43 is pushed upward by the locking protrusion 52. As a result, the module component 5 is locked by the locking plate 43, and thus is not pulled out from the cage 4.

When releasing the module component 5 from the cage 4, the unlocking lever 13 of the lever device 10 is drawn up and pulled as illustrated in FIGS. 7A to 7D. Then, with the operation of the tapered portions 15 of the slides rod illustrated in FIG. 7D, the tapered portions 15 are moved upward from the top surface 54 of the housing 50 and push the locking plate 43 upward as illustrated in FIGS. 8E and 8F. As a result, the module component 5 locked by the locking plate 43 is unlocked. In this state, when the module component 5 is further pulled, the module component 5 is able to be extracted from the cage 4.

However, even though both of the dimension of the locking plate of the cage and the dimension of the locking protrusion of the module component are within the standard dimensions in the combination of the cage and the module components, there is a case in which a problem occurs that causes the locked state not to be released so that the module component is not be able to be extracted. For example, this problem occurs when the tapered portion is not able to sufficiently move the locking plate upward even though the unlocking lever of the lever device is drawn up and pulled. In this case, when the module component is forcibly extracted from the cage, a metal sheet of the case suffers from warpage deformation at a portion fitted to the locking plate, and thus, the module component fitted to the case is not able be released.

Further, in the case where the module component is not able be extracted from the cage even though the unlocking lever of the lever device is drawn up and pulled, the module component is forcedly extracted in a state in which the locking plate is forcedly drawn up by using a tool such as tweezers from the outside. Because the operation of drawing up the locking plate by using the tool is a delicate work that requires a skill, and a portion of the cage fitted to the locking plate is likely to be deformed and damaged. In addition, even in the case in which the module may be extracted from the cage by the tweezers, the module may suddenly fall off.

The following is a reference document.

### [Document 1] Japanese Laid-Open Patent Publication No. 05-309575.

### SUMMARY

According to an aspect of the invention, an extracting tool for a module component, the extracting tool includes: a first member including, at a front end portion thereof, a hook that is engaged with a stepped portion formed a module component that is fitted to a cage and locked by a lock plate, the stepped portion being formed at a portion on the module component which is exposed from the cage; and a second member coupled with the first member at a rear end portion thereof, and including, at a front end portion thereof, a blade that, when the hook is engaged with the stepped portion, is inserted into a gap between the module component and the cage and pushes the locking plate upward to release a locked state, wherein, when releasing the module component from the cage, the first member and the second member are moved away from the cage in a state where the hook is engaged with the stepped portion and the blade releases the locked state.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view illustrating a structure of a communication device between electronic devices using module components and optical cables;

FIG. 2 is a perspective view illustrating a state in which the optical cables are removed from the module component equipped in the electronic device;

FIG. 3A is a perspective view illustrating a state in which the optical cables are connected, via a connector, with the module component extracted from the electronic device;

FIG. 3B is a perspective view illustrating a state in which the optical cables are removed from the module component illustrated in FIG. 3A;

FIG. 4A is a side view of an example of the module component; FIG. 4B is a top plan view of the module component illustrated in FIG. 4A;

FIG. 5 is a perspective view illustrating an example of a cage which is mounted on a circuit board of the electronic device and accommodates the module component;

FIG. 6A is a side view illustrating a state immediately before the module component is inserted into an opening portion of the cage mounted on the circuit board of the electronic device;

FIG. 6B is a side view illustrating a state in which the module component is fitted to the cage illustrated in FIG. 6A;

FIG. 6C is a side view illustrating a state in which an unlocking lever provided on the module component is drawn up in order to remove the module component from the state illustrated in FIG. 6B;

FIG. 6D is a side view illustrating a state in which the module component is extracted from the cage in a state in which the unlocking lever is drawn up;

FIG. 7A is a perspective view illustrating an example of a structure of a lever device provided on the module component;

FIG. 7B is a schematic side view illustrating an operation of a slide rod when the unlocking lever is moved up and extended;

FIG. 7C is a partially enlarged cross-sectional view illustrating a relationship among a housing, the slide rod, and the locking plate in a state in which the unlocking lever is not drawn up;

FIG. 7D is a partially enlarged cross-sectional view explaining operations of the slide rod and the locking plate when the unlocking lever is drawn up and pulled;

FIG. 8A is a cross-sectional side view of a main part when the module component is inserted into the cage;

FIG. 8B is a perspective view of the state illustrated in FIG. 8A;

FIG. 8C is a cross-sectional side view of the main part when the module component is inserted into, fitted to, and locked in the cage;

FIG. 8D is a perspective view of the state illustrated in FIG. 8C;

FIG. 8E is a cross-sectional side view of the main part when the unlocking lever is drawn up and the module component locked by the locking plate is unlocked;

FIG. 8F is a perspective view of the state illustrated in FIG. 8E;

FIG. 9A is a top plan view of an extracting tool for a module component of a first exemplary embodiment;

FIG. 9B is a side view of the extracting tool illustrated in FIG. 9A;

FIG. 9C is a bottom plan view of the extracting tool illustrated in FIG. 9A;

FIG. 10 is a cross-sectional side view illustrating a state immediately before the extracting tool illustrated in FIGS. 9A to 9C is fitted to a module component fitted to a cage;

FIG. 11A is a cross-sectional side view illustrating a state in which the extracting tool is being fitted to the module component from the state illustrated in FIG. 10;

FIG. 11B is an enlarged cross-sectional side view of a main part in the state illustrated in FIG. 11A;

FIG. 11C is a perspective view of the state illustrated in FIG. 11B;

FIG. 12A is a cross-sectional side view illustrating a state in which the extracting tool is fitted to the module component and a locking plate is drawn up from the state illustrated in FIG. 11A;

FIG. 12B is an enlarged cross-sectional side view of the main part in the state illustrated in FIG. 12A;

FIG. 12C is a perspective view of the state illustrated in FIG. 12B;

FIG. 12D is a cross-sectional side view illustrating only the module component and the extracting tool extracted from the state illustrated in FIG. 12A;

FIG. 13A is an enlarged cross-sectional side view of the main part illustrating a state in which the module component is extracted by the extracting tool from the state illustrated in FIG. 12B;

FIG. 13B is a perspective view of the state illustrated in FIG. 13A;

FIG. 13C is a cross-sectional side view illustrating a state in which the module component is being withdrawn from the cage by the extracting tool;

FIG. 14A is a top plan view of an extracting tool for a module component of a second exemplary embodiment;

FIG. 14B is a side view of the extracting tool illustrated in FIG. 14A;

FIG. 14C is a front view of the extracting tool illustrated in FIG. 14B;

FIG. 15A is a side view illustrating, in comparison, a state before a pressing portion of the extracting tool of the second exemplary embodiment is pushed and a state after the pressing portion is pushed;

FIG. 15B is a front view illustrating, in comparison, the state before the pressing portion of the extracting tool of the second exemplary embodiment is pushed and the state after the pressing portion is pushed;

FIG. 15C is a top plan view illustrating, in comparison, the state before the pressing portion of the extracting tool of the second exemplary embodiment is pushed and the state after the pressing portion is pushed;

FIG. 16A is a side view, a front view, and a top plan view of an extracting tool for a module component of a third exemplary embodiment;

FIG. 16B is a side view, a front view, and a top plan view of a state in which a pressing portion of the extracting tool of the third exemplary embodiment is pushed;

FIG. 17A is a top plan view of an extracting tool of a modification of the third exemplary embodiment in which a handle is provided;

FIG. 17B is a side view of the extracting tool of the modification of the third exemplary embodiment in which the handle is provided;

FIG. 17C is a front view of the extracting tool of the modification of the third exemplary embodiment in which the handle is provided;

FIG. 17D is a bottom plan view of the extracting tool of the modification of the third exemplary embodiment in which the handle is installed;

FIG. 18 is a cross-sectional view illustrating a modification of a method of attaching the pressing portion of the second exemplary embodiment;

FIG. 19 is a side view of an extracting tool of a fourth exemplary embodiment;

FIG. 20A is a side view of an extracting tool of a fifth exemplary embodiment;

FIG. 20B is a side view illustrating a state when a ring of the extracting tool illustrated in FIG. 20A is moved to a position where the module component may be held;

FIG. 20C is a front view of the extracting tool illustrated in FIG. 20B;

FIG. 21 is a side view of an extracting tool of a sixth exemplary embodiment; and

FIG. 22 is a side view of an extracting tool of a seventh exemplary embodiment.

### DESCRIPTION OF EMBODIMENTS

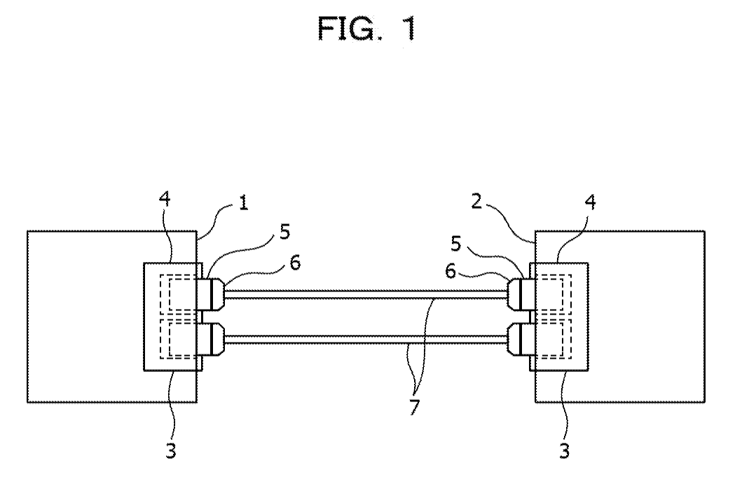

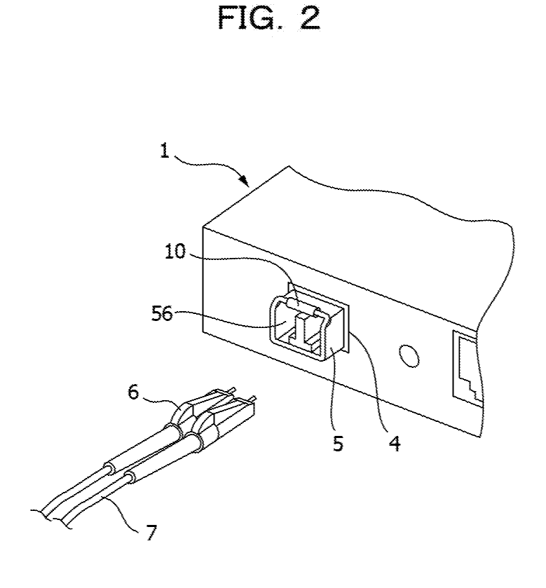

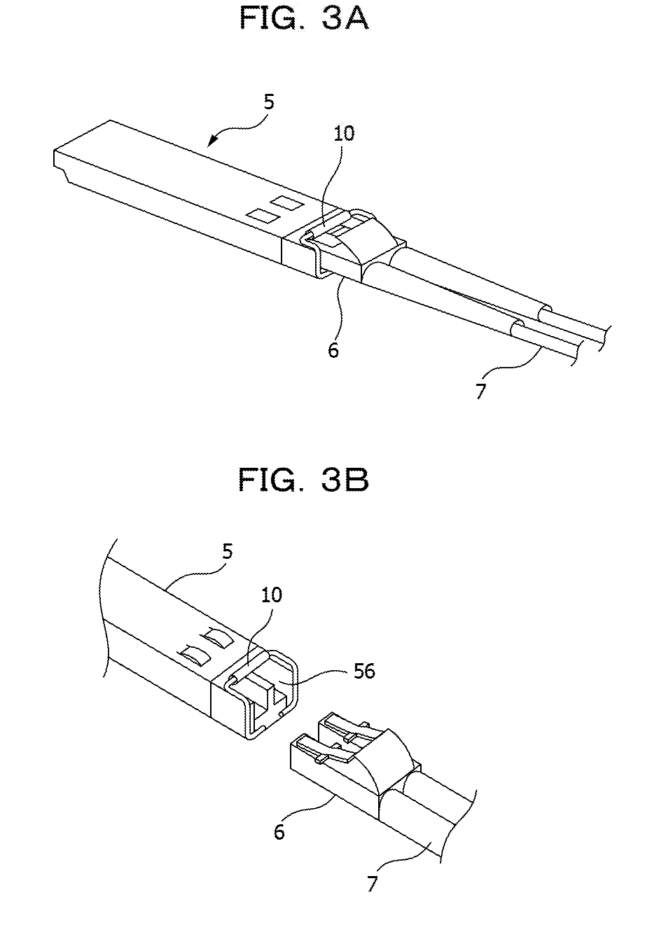

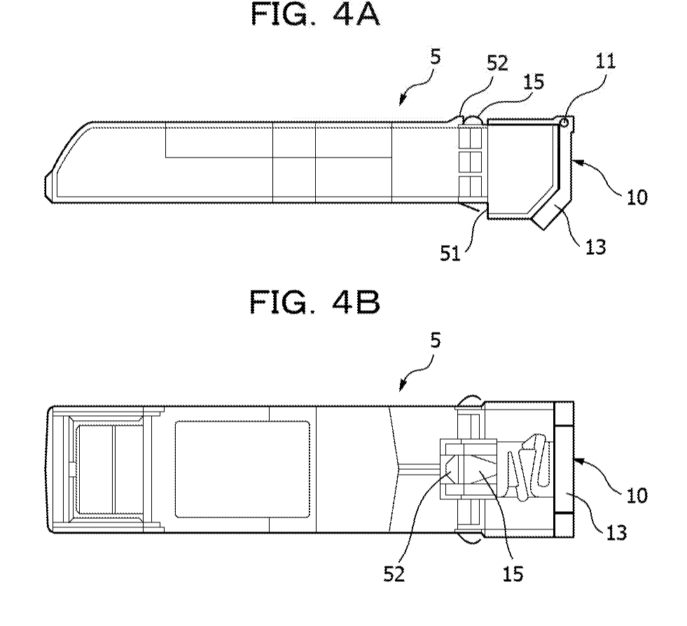

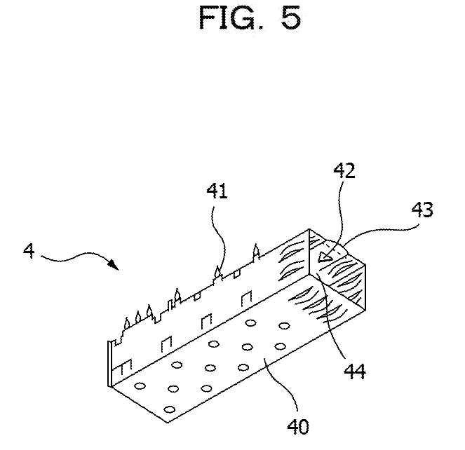

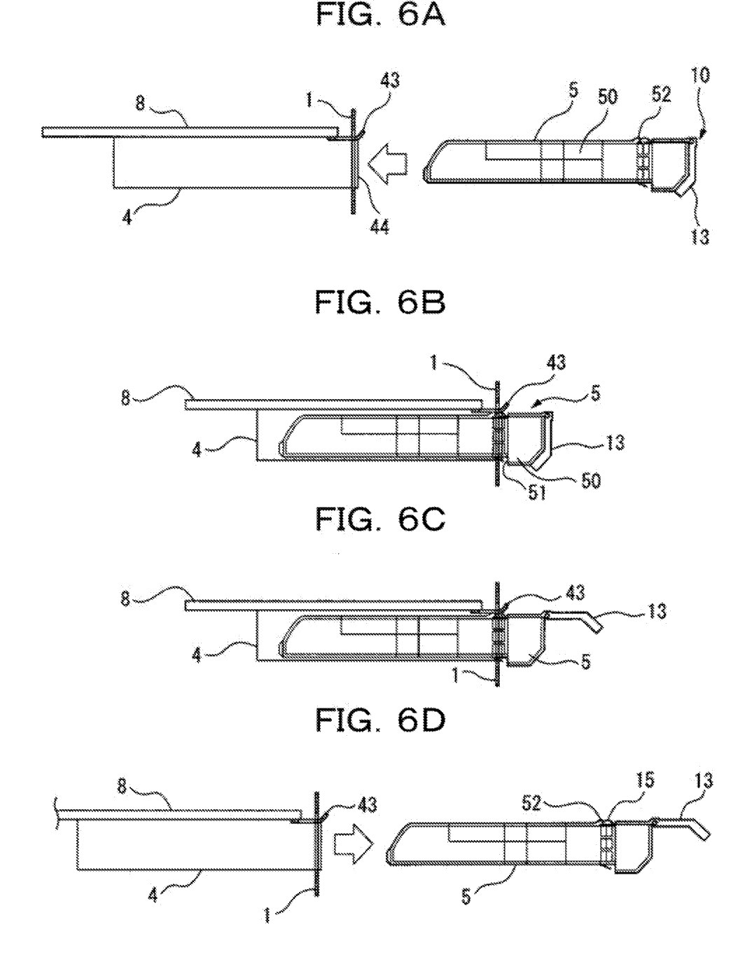

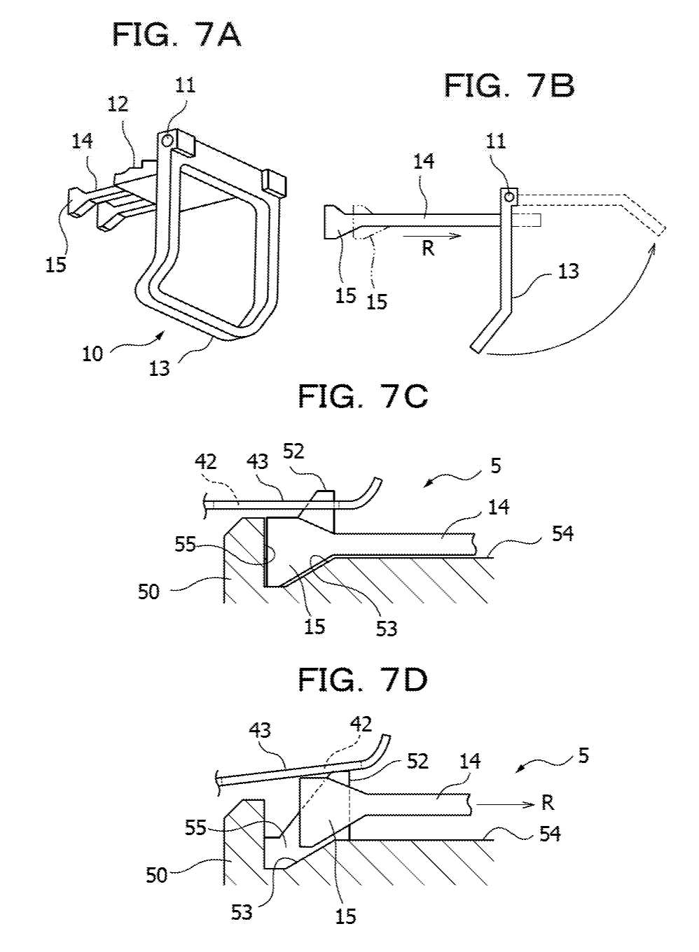

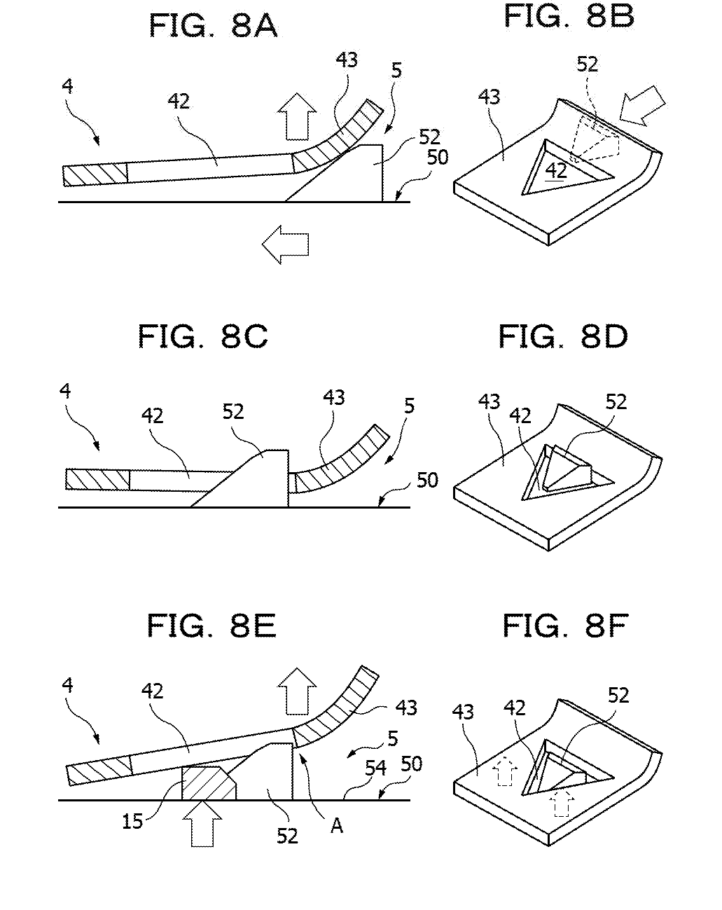

Hereinafter, based on specific examples, exemplary embodiments of an extracting tool for a module component of the present application will be described in detail with reference to the accompanying drawings. In addition, because a structure of a module component to be extracted by using a disclosed extracting tool and a structure of a cage to which a module component is fitted are the same as the structures of the module component and the cage which have been described with reference to FIGS. 1 to 8, the same components are designated by the same reference numerals, and descriptions thereof will be omitted.

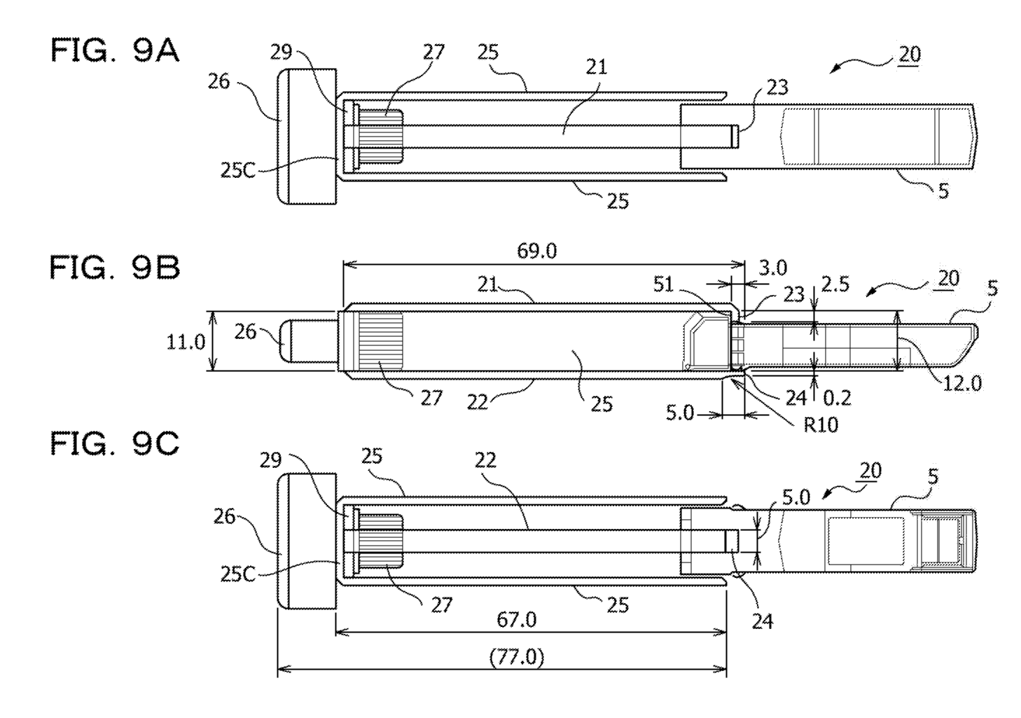

FIG. 9A is a top plan view of an extracting tool 20 for a module component 5 according to a first exemplary embodiment, FIG. 9B is a side view of the extracting tool 20 illustrated in FIG. 9A, and FIG. 9C is a bottom plan view of the extracting tool 20 illustrated in FIG. 9A and also illustrates the module component 5. The extracting tool 20 of the first exemplary embodiment includes a first member 21, a second member 22, guide plates 25, a handle 26, and an attachment screw 27. In the present exemplary embodiment, the first member 21 and the second member 22 are integrally formed. That is, in the present exemplary embodiment, the first member 21 and the second member 22 are formed by bending two thin plate-shaped members, which are installed at an opposite position to a metallic base portion 29 through which the attachment screw 27 is inserted, to be in parallel with each other. The first member 21 and the second member 22 are flexible. The first member 21 and the second member 22 may be separate members, and at least one of the first member 21 and the second member 22 may be flexible.

A hook 23 is provided at a front end portion of the first member 21. The hook 23 is configured to be engaged with a stepped portion 51 provided on a portion exposed from the cage on the module component 5 that is fitted to the cage and locked by the locking plate. A blade 24 is provided at a front end portion of the second member 22. When the hook 23 provided on the first member 21 is engaged with the stepped portion 51, the blade 24 is fitted to a gap of the cage for the module component 5, and functions to push the locking plate provided on the cage upward. The hook 23 and the blade 24 face each other at the front end portions of the first member 21 and the second member 22.

The guide plates 25 provided in the extracting tool 20 of the first exemplary embodiment are provided to be fitted to a space between the first and second members 21 and 22 from both sides thereof, and the guide plates 25 are formed by bending one sheet of metallic plate in a U shape. In the present exemplary embodiment, a bent portion 25C of the guide plates 25 overlap with the base portion 29 of the first member 21 and the second member 22, and is fixed to the handle by the attachment screw 27. Front end portions of the guide plates 25 reach the front end portions of the first and second members 21 and 22, and serve as a guide when the blade 24 is inserted into the gap between the module component 5 and the cage. The interval between the guide plates 25 is equal to the width of the module component 5 which is fitted to the cage and exposed from the cage, and the interval between the guide plates 25 is an interval that does not hinder the operation of holding the module component 5 by the hook 23 and the blade 24. In addition, when the extracting tool 20 holds the module component 5, the guide plates 25 also have a function of maintaining the module component 5 not to fall off by holding the module component 5 from all sides.

In the first exemplary embodiment, as described above, the bent portion 25C of the guide plates 25 overlaps with the base portion 29 of the first member 21 and the second member 22, and is attached to the handle 26 by the attachment screw 27. The handle 26 is provided to allow a user to easily hold the extracting tool 20 when extracting the module component 5 from the cage. The handle 26 may not be particularly provided on the extracting tool 20.

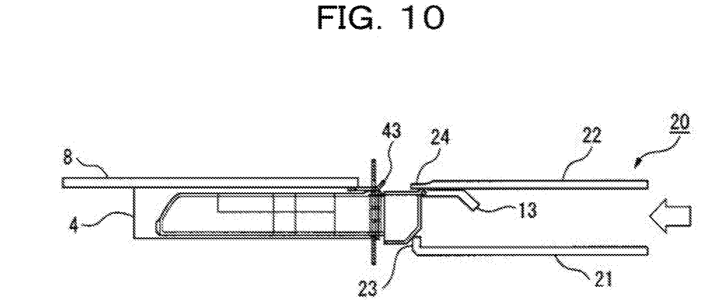

FIG. 10 is a cross-sectional side view illustrating a state immediately before the extracting tool 20 illustrated in FIGS. 9A to 9C is fitted to the module component 5 fitted to the cage 4. When extracting the module component 5 from the cage 4 using the extracting tool 20, the operation is performed in a state in which the unlocking lever 13 of the module component 5 is drawn up from the module component 5.

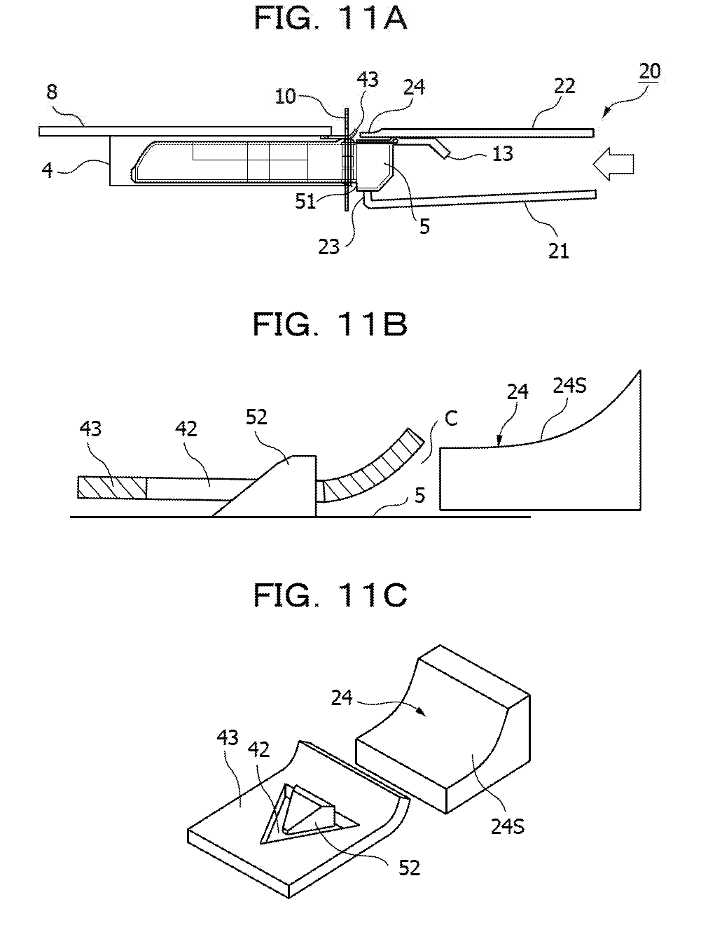

FIG. 11A is a cross-sectional side view illustrating a state in which the extracting tool 20 is being fitted to the module component 5 from the state illustrated in FIG. 10. In addition, FIG. 10B is an enlarged cross-sectional side view of the main part in the state illustrated in FIG. 10A, and FIG. 10C is a perspective view of the state illustrated in FIG. 10B. Because a portion of the module component 5, which is exposed from the cage 4, is tapered, the first member 21 may be bent by the tapered portion, and the hook 23 of the extracting tool 20 may reach a bottom surface of the module component 5. In a state in which the module component 5 is fitted to the cage 4, the locking protrusion 52 provided on the top surface of the module component 5 is positioned in the locking protrusion fitting hole 42 provided in the locking plate 43 of the cage 4 as illustrated in FIGS. 11B and 11C.

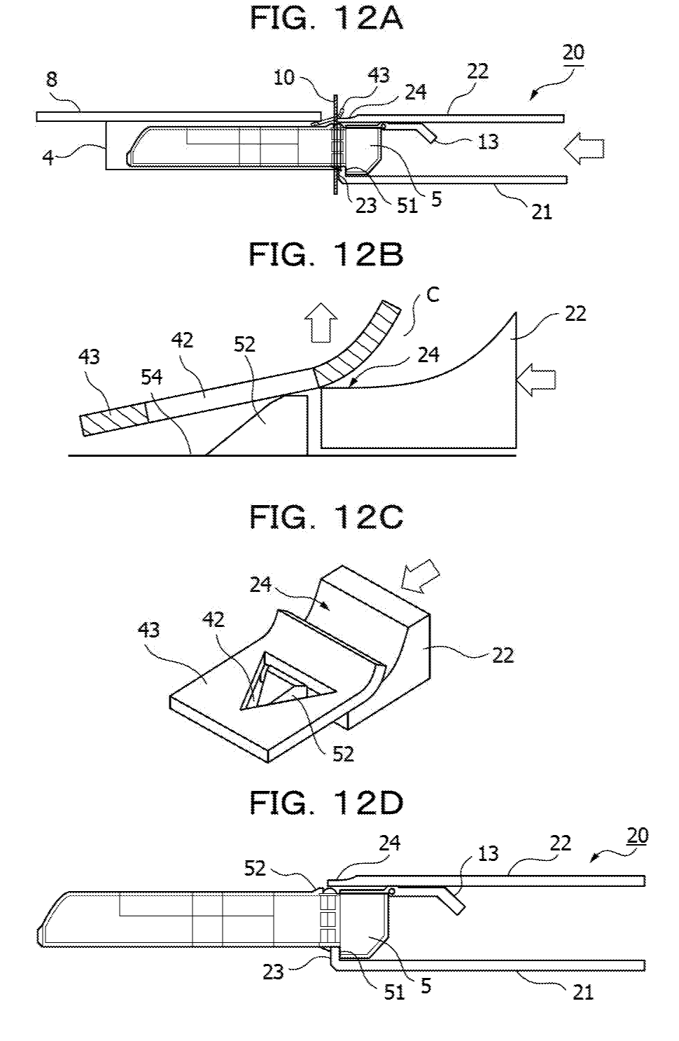

FIG. 12A is a cross-sectional side view illustrating a state in which the extracting tool 20 is fitted to the module component 5 and the locking plate 43 is pushed up from the state illustrated in FIGS. 11A to 11C. In addition, FIG. 12B is an enlarged cross-sectional side view of the main part in the state illustrated in FIG. 12A, and FIG. 12C is a perspective view of the state illustrated in FIG. 12B. In addition, FIG. 12D is a cross-sectional side view illustrating only the module component 5 and the extracting tool 20 extracted from the state illustrated in FIG. 12A. The state in which the locking plate 43 is pushed up by the blade 24 provided on the second member 22 of the extracting tool 20 is illustrated in detail in FIGS. 12B and 12C. When the extracting tool 20 is inserted into the gap C between the module component 5 and the cage 4, the blade 24 provided at the front end portion of the second member 22 slides to a lower side of the locking plate 43, and the locking plate 43 is pushed up by an inclined surface of the blade 24.

When the locking plate 43 is pushed up by the blade 24, a height from the top surface 54 of the module component 5 at the bottom surface of the locking plate 43 exceeds a height of the locking protrusion 52 protruding on the module component 5 as illustrated in FIG. 12B. Therefore, as the extracting tool 20 is inserted between the cage 4 and the module component 5, the locked state of the module component 5 and the cage 4 is released.

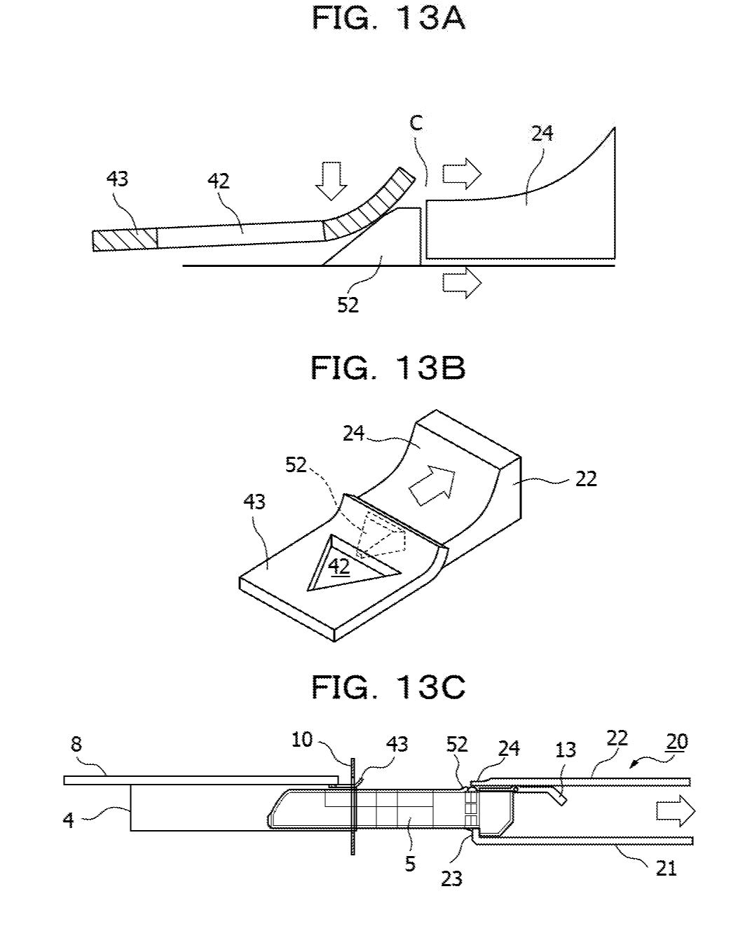

FIG. 13A is an enlarged cross-sectional side view of the main part illustrating a state in which the module component 5 is being pulled out by the extracting tool 20 from the state illustrated in FIG. 12B. In addition, FIG. 13B is a perspective view of the state illustrated in FIG. 13A, FIG. 13C is a cross-sectional side view illustrating a state in which the module component 5 is being pulled out from the cage 4 by the extracting tool. When the first member 21 and the second member 22 are moved away from the cage 4 in a state in which the hook 23 is engaged with the stepped portion 51 and the blade 24 is unlocked, the module component 5 may be released from the cage 4.

As described above, according to the extracting tool 20 of the first exemplary embodiment, when the blade 24 of the extracting tool 20 is inserted into the gap between the cage 4 and the module component 5, the hook 23 is simply engaged with the stepped portion 51 of the module component 5. In a state in which the hook 23 is engaged with the stepped portion 51 of the module component 5, the blade 24 pushes the locking plate 43 of the cage 4 upward, and the module component 5 locked by the locking plate 43 is unlocked. Therefore, when the extracting tool 20 is moved away from the cage 4 in this state, it is ensured that the module component 5 may be safely extracted from the cage 4. The module component 5 held by the extracting tool 20 may be extracted by increasing the interval between the first member 21 and the second member 22 of the extracting tool 20.

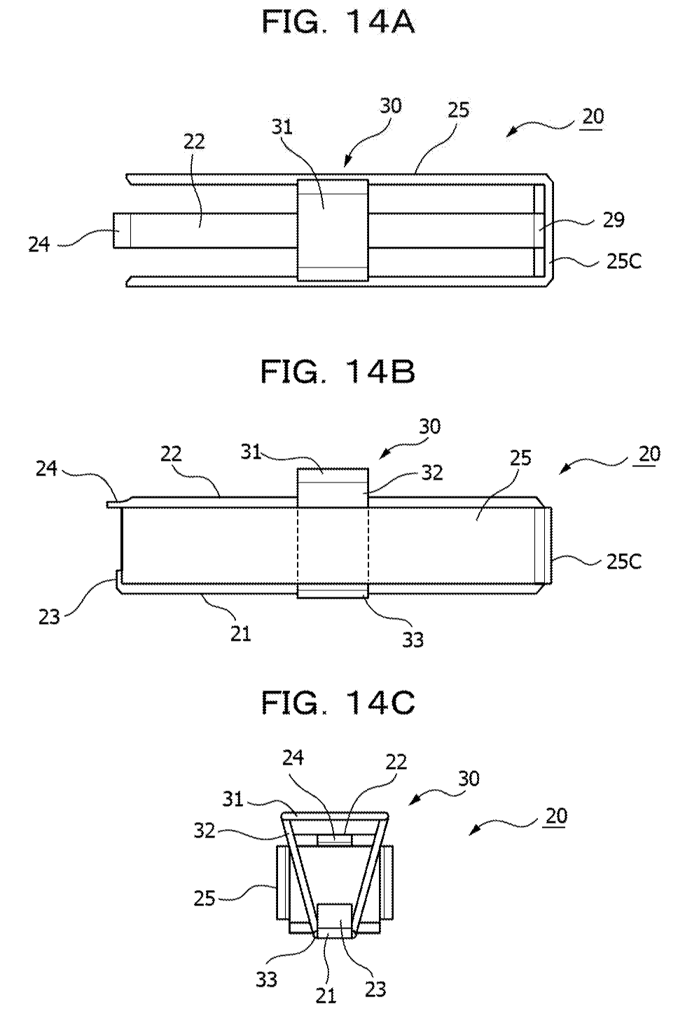

FIG. 14A is a top plan view of an extracting tool 20 for a module component 5 according to a second exemplary embodiment, FIG. 14B is a side view of the extracting tool 20 illustrated in FIG. 14A, and FIG. 14C is a front view of the extracting tool 20 illustrated in FIG. 14B. In the extracting tool 20 of the second exemplary embodiment, neither the handle 26 nor the attachment screw 27 is provided at a superimposed portion of the base portion 29 of the first and second members 21 and 22 and the bent portion 25C of the guide plates 25. In addition, in the extracting tool 20 of the second exemplary embodiment, a release member 30 is provided at a central portion in a longitudinal direction of the first and second members 21 and 22. The base portion 29 of the first and second members 21 and 22 and the bent portion 25C of the guide plates 25 may be superimposed by welding or bonding.

The release member 30 increases the interval between the front end portions of the first and second members 21 and 22 by being pressed from the second member 22 so as to remove the module component 5 held by the first and second members 21 and 22 from the extracting tool 20. The release member 30 of the present exemplary embodiment includes an attaching portion 33 bonded to the first member 21, sidewall portions 32 extending from the both end portions of the attaching portion 33 to the second member 22, and a pressing portion 31 disposed at a portion of the second member 22 opposite to the first member 21 and connecting the front end portions of the sidewall portions 32 to each other.

An interval between the pressing portion 31 and the second member 22 is an interval that enables the hook 23 to move to a position for releasing the engagement with the stepped portion 51 when the pressing portion 31 is brought closer to the second member 22 by bending the first member 21. The length of the pressing portion 31 of the release member 30 in a direction orthogonal to the longitudinal direction of the second member 22 is longer than the length of the attaching portion 33 in a direction orthogonal to the longitudinal direction of the first member 21, and the sidewall portions 32 pass through a gap between the guide plates 25 and the second member 22. For this reason, when the pressing portion 31 is brought to closer to the second member 22, the interval between the opposite guide plates 25 is made to be extendible by the sidewall portions 32.

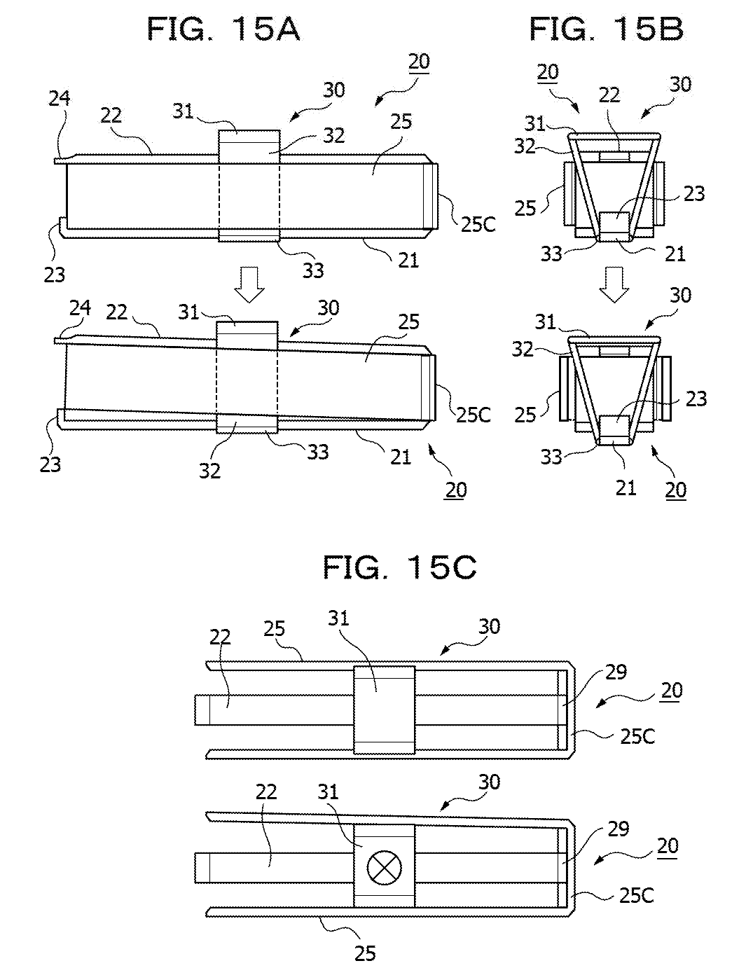

FIG. 15A a side view illustrating, in comparison, a state before the pressing portion 31 of the extracting tool 20 of the second exemplary embodiment is pushed and a state after the pressing portion 31 is pushed. In addition, FIG. 15B is a front view illustrating, in comparison the state before the pressing portion 31 of the extracting tool 20 of the second exemplary embodiment is pushed and the state after the pressing portion 31 is pushed. In addition, FIG. 15C is a top plan view illustrating, in comparison, the state before the pressing portion 31 of the extracting tool 20 of the second exemplary embodiment is pushed and the state after the pressing portion 31 is pushed. By pushing the pressing portion 31 as described above, the interval between the front end portions of the first and second members 21 and 22 of the extracting tool 20 and the intervals of the front end portions of the two guide plates 25 are increased, and as a result, the module component held by the extracting tool 20 may be easily released from the extracting tool 20.

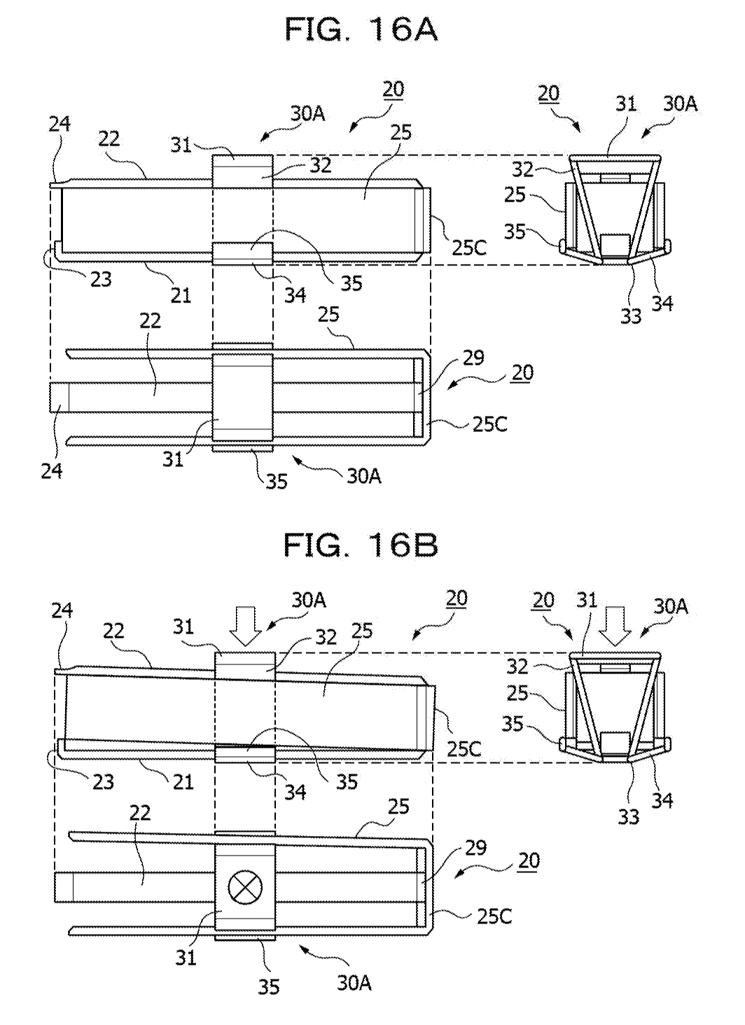

FIG. 16A illustrates a side view, a front view, and a top plan view of an extracting tool 20 for a module component 5 according to a third exemplary embodiment. In addition, FIG. 16B is a side view, a front view, and a top plan view illustrating a state in which the pressing portion 31 of the extracting tool 20 of the third exemplary embodiment is pushed. The extracting tool 20 of the third exemplary embodiment is different from the extracting tool 20 of the second exemplary embodiment in terms of the structure of the attaching portion 33 of the release member 30. The extracting tool 20 of the second embodiment and the extracting tool 20 of the third embodiment are different from each other in that, in the extracting tool 20 of the second embodiment, the sidewall portions 32 are bonded to a side surface of the first member 21, but in the extracting tool 20 of the third embodiment, lock plates 34 having stoppers 35 at front end portions thereof are provided on the attaching portion 33 of the sidewall portions 32 for the first member 21.

The lock plates 34 extend from the attaching portion 33 toward the opposite guide plates 25, respectively, and in a state in which the pressing portion 31 is not pushed, the stoppers 35 provided on the front end portions of the lock plates 34 are positioned outside the guide plates 25 and suppress the guide plates 25 from being widened. As the stoppers 35 suppress the guide plates 25 from being widened, the module component 5 may be maintained so as not to be fall off after being extracted. That is, the stoppers 35 have a function of maintaining and securing the holding force of the guide plates 25. When the pressing portion 31 is pushed, the stoppers 35 are moved downward, and as a result, the guide plates 25 may be widened outward. In addition, when the pressing portion 31 is not pushed, the stoppers 35 return back to the original position, thereby suppressing the guide plates 25 from being widened.

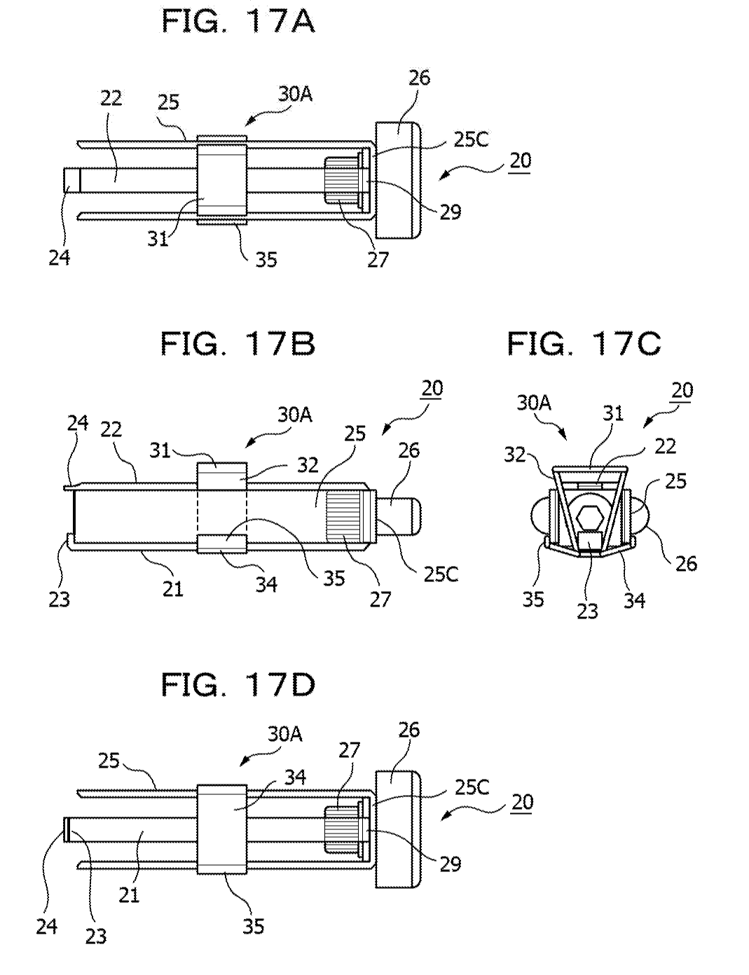

FIG. 17A is a top plan view of the extracting tool 20 of a modification of the third exemplary embodiment in which the handle 26 and the attachment screw 27 are provided, and FIG. 17B is a side view of the extracting tool 20 of the modification of the third exemplary embodiment in which the handle 26 and the attachment screw 27 are provided. In addition, FIG. 17C is a front view of the extracting tool 20 of the modification of the third exemplary embodiment in which the handle 26 and the attachment screw 27 are provided, and FIG. 17D is a bottom plan view of the extracting tool 20 of the modification of the third exemplary embodiment in which the handle 26 and the attachment screw 27 are provided. In the extracting tool 20 of the present exemplary embodiment, the base portion 29 of the first and second members 21 and 22 and the bent portion 25C of the guide plates 25 of the third exemplary embodiment are attached to the handle 26 by means of the attachment screw 27. Because an operation of the extracting tool 20 of the modification of the third exemplary embodiment is not different from that of the extracting tool 20 of the third exemplary embodiment, a further description will be omitted.

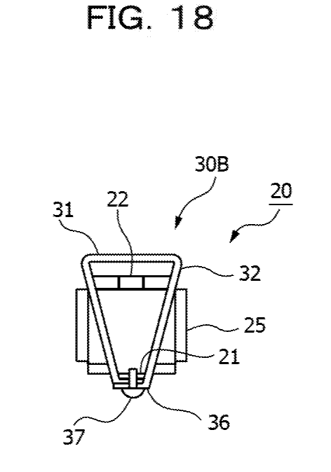

FIG. 18 is a cross-sectional view of a modification of a method of attaching the pressing portion 31 of the extracting tool 20 in the second exemplary embodiment. In the present exemplary embodiment, a superimposed portion 36 is defined as lower end portions of the sidewall portions 32 are superimposed on the bottom surface of the first member 21, and the superimposed portion 36 is attached to the first member 21 by a screw 37. Other features are identical to those in the second exemplary embodiment.

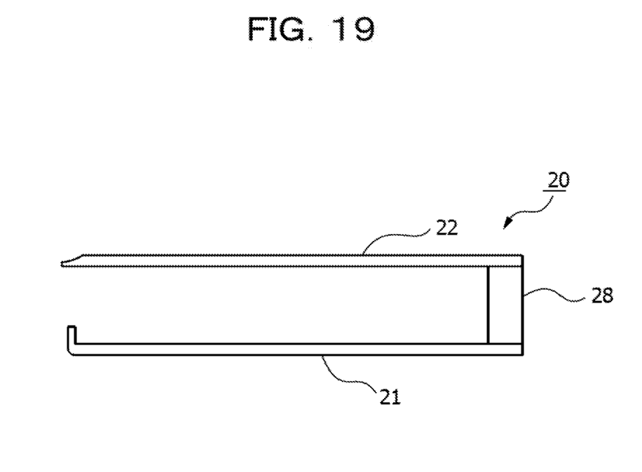

FIG. 19 is a side view of an extracting tool 20 of a fourth exemplary embodiment. In the extracting tool 20 of the fourth exemplary embodiment, a first member 21 and a second member 22 are formed as metallic thin plate-shaped members which are separate members. In the extracting tool 20 of the fourth exemplary embodiment, no guide plate is provided. Further, the first member 21 and the second member 22 are separate members, and coupled to each other by using a spacer 28 at rear end portions thereof. The spacer 28 may be made of a metal or resin. The fourth exemplary embodiment is identical to other exemplary embodiments in that the hook 23 and the blade 24 face each other at the front end portions of the first member 21 and the second member 22.

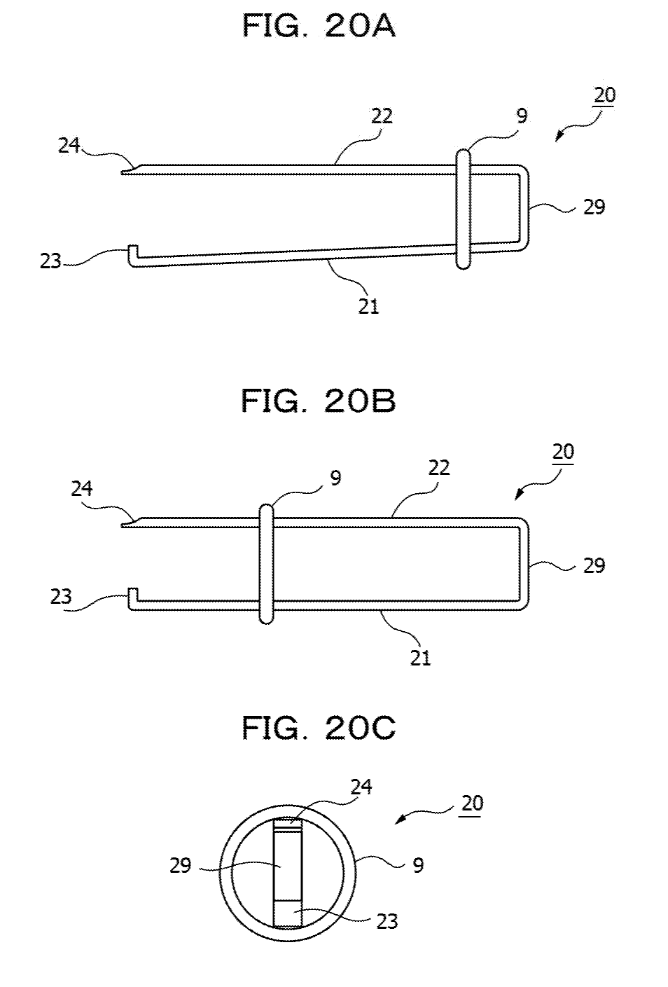

FIG. 20A is a side view of an extracting tool 20 of a fifth exemplary embodiment, and FIG. 20B is a side view of the extracting tool 20 when a ring 9 is moved to a position where the ring 9 is capable of holding the module component in the extracting tool 20 illustrated in FIG. 20A. The first member 21 and the second member 22, which are formed as metallic thin plate-shaped members, are integrally formed and connected through a base portion 29. For example, as illustrated in FIG. 20C, the ring 9 has a circular shape and is provided outside the first and second members 21 and 22. In the extracting tool 20 of the fifth exemplary embodiment, no guide plate is provided. When the ring 9 is moved toward the rear ends of the first and second members 21 and 22, the front end portions of the first and second members 21 and 22 are opened. On the contrary, when the ring 9 is moved toward the front end portions of the first and second members 21 and 22, the front end portions of the first and second members 21 and 22 are closed. The shape of the ring 9 may not be circular, and the ring may have any other shape as long as the shape encloses the outer portions of the first and second members 21 and 22.

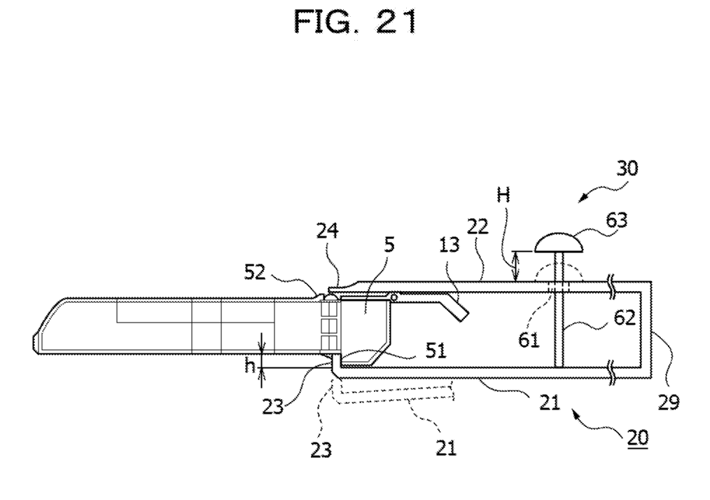

FIG. 21 is a side view of an extracting tool 20 of a sixth exemplary embodiment. In the present exemplary embodiment, a release member 30 includes a rod 62 installed to protrude on a first member 21, a through hole 61 provided in a second member 22 so as to allow the rod 62 to be inserted therethrough, and a button portion 63 provided at the front end portion of the rod 62. An interval H between the button portion 63 and the second member 22 may be an interval that enables the hook 23 to move over a height h of the stepped portion 51 when the button portion 63 is brought closer to the second member 22 to a position indicated by a broken line by bending the first member 21. When the button portion 63 is moved to the position indicated by the broken line, the front end portion of the first member 21 is moved to a position indicated by a broken line, which enables the module component 5 held by the first and second members 21 and 22 to be removed from the extracting tool 20.

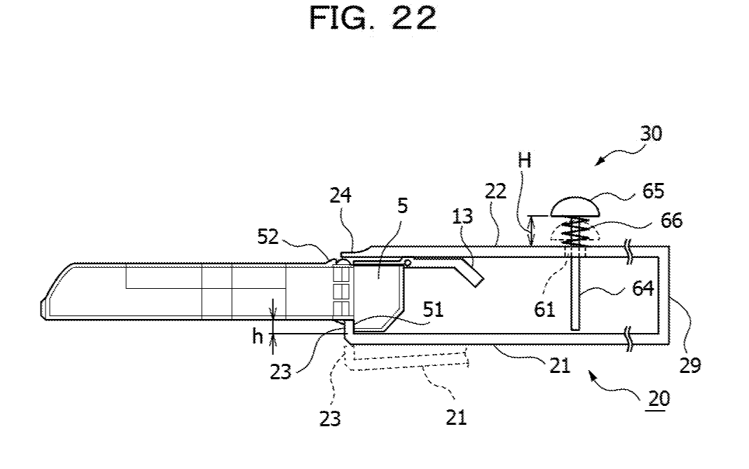

FIG. 22 is a side view of an extracting tool 20 of a seventh exemplary embodiment. In the present exemplary embodiment, a release member 30 includes a rod 64 having a front end portion inserted through a through hole 61 provided in the second member 22 to be in contact with the first member 21, and a rear end portion protruding from the second member 22, and a button portion 65 provided on the rear end portion of the rod 64. The button portion 65 is maintained at a position spaced apart from the second member 22 by a spring 66 which is an elastic member. An interval H between the button portion 65 and the second member 22 may be an interval that enables the hook 23 to move over a height h of the stepped portion 51 when the button portion 65 is brought closer to the second member 22 by bending the first member 21. When the button portion 65 is moved to the position indicated by the broken line, the front end portion of the first member 21 is moved to a position indicated by a broken line, which enables the module component 5 held by the first and second members 21 and 22 to be removed from the extracting tool 20.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An extracting tool for a module component, the extracting tool comprising:
a first member including, at a front end portion thereof, a hook that is engaged with a stepped portion formed a module component that is fitted to a cage and locked by a lock plate, the stepped portion being formed at a portion on the module component which is exposed from the cage; and
a second member coupled with the first member at a rear end portion thereof, and including, at a front end portion thereof, a blade that, when the hook is engaged with the stepped portion, is inserted into a gap between the module component and the cage and pushes the locking plate upward to release a locked state,
wherein, when releasing the module component from the cage, the first member and the second member are moved away from the cage in a state where the hook is engaged with the stepped portion and the blade releases the locked state.

2. The extracting tool according to claim 1, wherein
the first member and the second member are integrally formed as a single metallic thin plate-shaped member, a rear end portion of the first member and the second member is bent in a U shape, and the hook and the blade face each other at the front end portions of the first member and the second member.

3. The extracting tool according to claim 1, wherein the first member and the second member are metallic thin plate-shaped members that are separate members, and are coupled to each other at rear end portions thereof by a spacer, and the hook and the blade face each other at the front end portions of the first member and the second member.

4. The extracting tool according to claim 1, wherein
an inclined surface is formed on a front end portion of the blade to push the locking plate upward, thereby releasing the locked state.

5. The extracting tool according to claim 1, wherein
a length from the rear end portion to the front end portion of the second member is longer than a length from the rear end portion to the front end portion of the first member,
a locking protrusion is formed on the module component to be locked by the locking plate, and
a difference in length between the first member and the second member is shorter than a length from the stepped portion to an end portion of the locking protrusion in a direction in which the module component is inserted into the cage.

6. The extracting tool according to claim 1, wherein
the first member and the second member are flexible.

7. The extracting tool according to claim 6, wherein
an interval between the rear end portions of the first member and the second member is smaller than an interval between the front end portions of the first member and the second member, and
the hook is engaged with the stepped portion by decreasing the interval between the front end portions of the first member and the second member in a state where the blade is inserted into the gap.

8. The extracting tool according to claim 7, wherein
a ring enclosing an outside of the first member and the second member, is movably attached to the rear end portions of the first member and the second member, and
the interval between the front end portions of the first member and the second member is decreased by moving the ring toward the front end portions.

9. The extracting tool according to claim 6, wherein
the first member and the second member are formed to be parallel with each other, and
as the blade is inserted into the gap, an interval between the front end portion of the first member and the second member is increased by a shape of the module component, and the hook is engaged with the stepped portion.

10. The extracting tool according to claim 9, wherein
a release member is installed between the first member and the second member to increase the interval between the front end portions the first member and the second member by being pressed from the second member side.

11. The extracting tool according to claim 10, wherein
the release member includes an attaching portion fixed to the first member, sidewall portions extending from opposite end portions of the attaching portion toward the second member, respectively, and a pressing portion coupling front end portions of the sidewall portions at the opposite side of the second member to the first member, and
an interval between the pressing portion and the second member is an interval that enables the hook to move to a position for releasing the engagement with the stepped portion when the pressing portion is brought closer to the second member by bending the first member.

12. The extracting tool according to claim 10, wherein
the release member includes a rod installed to protrude on the first member and inserted through a through hole formed in the second member such that a front end portion of the rod protrudes from the second member, and a button portion installed on the front end portion of the rod, and
an interval between the button portion and the second member is an interval that enables the hook to move over a height of the stepped portion when the button portion is brought closer to the second member by bending the first member.

13. The extracting tool according to claim 10, wherein
the release member includes a rod having a front end portion inserted through a through hole formed in the second member to be in contact with the first member and a rear end portion protruding from the second member, a button portion installed on the rear end portion of the rod, and an elastic member that maintains the button portion at a position spaced apart from the second member, and
an interval between the button portion and the second member is an interval that enables the hook to move over a height of the stepped portion when the button portion is brought closer to the second member by bending the first member.

14. The extracting tool according to claim 10, wherein
the release member is installed at a position that bisects a length from the front end portions to the rear end portions of the first and second members.

15. The extracting tool according to claim 1, further comprising:
guide members installed at opposite sides of a space between the first and second members, respectively, the guide members having a base portion that is coupled to the rear end portions of the first and second members and front end portions that reach the front end portions of the first and second members and serve as a guide when the blade is inserted into the gap,
wherein an interval between the guide members is substantially equal to a width of the module component fitted to the cage and exposed from the cage, and the interval between the guide members is an interval that does not hinder an operation of holding the module component by the hook and the blade.

16. The extracting tool according to claim 11, further comprising:
guide members installed at opposite sides of a space between the first and second members, respectively, the guide members having a base portion that is coupled to the rear end portions of the first and second members and front end portions that reach the front end portions of the first and second members and serve as a guide when the blade is inserted into the gap,
wherein an interval between the guide members is substantially equal to a width of the module component fitted to the cage and exposed from the cage, and the interval between the guide members is an interval that does not hinder an operation of holding the module component by the hook and the blade,
a length of the pressing portion of the release member in a direction orthogonal to the longitudinal direction of the second member is longer than a length of the attaching portion in a direction orthogonal to the longitudinal direction of the first member, the sidewall portions passing through a gap between the guide members and the second member, and
when the pressing portion is brought closer to the second member, the interval between the opposite guide members is increased by the sidewall portions.
